(19) United States
(12) Patent Application Publication
(10) Pub. No.: US 2011/0010280 A1
(43) Pub. Date: Jan. 13, 2011

(54) SYSTEM AND METHOD FOR CREATING A TIME SHEET

(75) Inventors: David Hiscock, Carbonear (CA); Ronald Peddle, Paradise (CA); Douglas Jackman, Mt. Pearl (CA)

Correspondence Address: MOORE & VAN ALLEN PLLC, P.O. BOX 13706, Research Triangle Park, NC, 27709, US

(73) Assignee: ACZEN INNOVATIONS INC., St. John's (CA)

(21) Appl. No.: 12/833,715

(22) Filed: Jul. 9, 2010

Related U.S. Application Data
(60) Provisional application No. 61/224,183, filed on Jul. 9, 2009.

(51) Int. Cl. G06Q 10/00

(52) U.S. Cl. 705/32

(57) ABSTRACT

A system and method for creating a time sheet. The system collects at a reporting device, chronologically-identifiable log entries from a variety of activity recording devices, including without limitation, mobile, desktop and networked phones, PDAs, media recorders, satellite positioning systems, handheld, mobile, desktop and networked computers. The reporting device allocates each of the log entries into one or more contiguous, non-overlapping and equal duration time blocks, corresponding to a minimum billing increment. The allocated log entries are processed by filtering, consolidation and sorting to identify an appropriate allocated log entry for each time block from which a time sheet may be generated comprising an identifier providing client or project information and a time value attributed to such activity. The time sheet may form an input into a time entry system. Methods of gathering chronologically-identifiable data at a recording device and of generating a time sheet at a reporting device are also disclosed.

### RELATED APPLICATIONS

The present disclosure claims priority from U.S. Provisional Patent Application No. 61/224,183 filed Jul. 9, 2009, the entirety of which is incorporated by reference herein.

### TECHNICAL FIELD

The present disclosure relates to time sheet entry systems and more particularly, to a system and method for creating a time sheet.

### INTRODUCTION

In the Information Age, increasingly, many businesses are entering the service or information industries. A hallmark of such industries is the provision of services on a “time billed” basis. Accordingly, increasingly, business owners and professionals are being asked to track time spent on client or project-related tasks for billing, auditing, project management and other purposes.

Most service providers encourage the recordal of billable time entries on an ongoing basis, but with the hectic nature of most service industries, it is often unrealistic to expect this to be undertaken by all professionals.

Unfortunately, it is often difficult to track ex post facto what time has been expended on which client or project, especially since much of the service provided may be from a common location using common resources such as a computer or telephone. As a result, much of a service provider's work product, namely billable hours, goes unrecorded and unbilled.

There are numerous mechanisms designed for facilitating time entry or otherwise improving upon the capture rate of work-related time. Many operate on the basis of logging computer activity in the background by monitoring a focus window. However, these systems are restricted to a single device, typically a work computer and are unable to take into account logs of activity on other business devices including without limitations telephones, personal digital assistants (PDAs) and the like, which are rapidly becoming part of the service provider's arsenal. These logs are usually presented on a chronological list or on a consolidated list that presents activity on duration.

There are numerous time sheet/accounting/practice management software packages which typically incorporate a single manual time entry system. Some systems enter total time spent on an activity per day, others enter time with start and finish times, and some offer time slots into which an activity is assigned. Usually the activity data is manually entered. In some cases, a timer application is provided to allow calculation of how much time was spent on a given activity.

### BRIEF DESCRIPTION OF THE DRAWINGS

FIG. 1 is a block diagram illustrating a system for creating a time sheet in accordance with one example embodiment of the present disclosure;

FIG. 2 is a block diagram illustrating the recording devices according to the example embodiment of FIG. 1;

FIG. 3(a) is a representational diagram showing an example embodiment of processing performed by a block allocator according to the example embodiment of FIG. 2 when a log entry does not straddle a time block boundary;

FIG. 3(b) is a representational diagram showing an example embodiment of processing performed by the block allocator according to the example embodiment of FIG. 2 when a log entry straddles at least one time block boundary;

FIG. 3(c) is a representational diagram showing an example embodiment of processing according to the example embodiment of FIG. 2 performed by a filter;

FIG. 3(d) is a representational diagram showing an example embodiment of processing according to the example embodiment of FIG. 2 performed by a consolidator;

FIG. 3(e) is a representational diagram showing an example embodiment of processing according to the example embodiment of FIG. 2 performed by a sorter;

FIG. 3(f) is a representational diagram showing an example embodiment of processing according to the example embodiment of FIG. 2 performed by a time sheet generator;

FIG. 4 is a flow chart showing example processing actions performed by the reporting devices according to the example embodiment of FIG. 1;

FIG. 5 is a flow chart showing example processing actions performed by the reporting devices according to the example embodiment of FIG. 1;

FIG. 6 is a flow chart showing example processing actions (on each log file in turn) performed by the reporting devices according to the example embodiment of FIG. 1; and

FIG. 7 is a flow chart showing example processing actions (all log files processed at the same time) performed by the reporting devices according to the example embodiment of FIG. 1.

Like reference numerals are used in the drawings to denote like elements and features.

### DESCRIPTION

The present disclosure relates to a system and method for creating a time sheet. The system automatically collects at a reporting device, log files of chronologically-identifiable log entries, from which may be determined or inferred a client-based identification, from a variety of activity recording devices. Such log files may be generated by a plurality of devices, including without limitations, mobile, desktop and networked phones, personal digital assistants, media player/recorders, satellite positioning systems, and handheld, mobile, desktop and networked computer systems.

The reporting device automatically allocates each of the collected log entries to one or more time blocks, which cover a desired reporting period. In some example embodiments, the time blocks are contiguous, non-overlapping and of equal duration, corresponding to a minimum billing increment. Once allocated, the allocated log entries may be processed by filtering, consolidation and sorting to identify an appropriate or dominant allocated log entry for each time block. Thereafter, a time sheet may be generated comprising a time sheet identifier which provides information about the client or project to which the activity is attributable and a time entry value corresponding to the product of the time interval of a time block and the number of time blocks attributed to such activity.

In some example embodiments, the time sheet may be further processed to form an input into a conventional time entry system.

Methods of gathering chronologically-identifiable data at a recording device and of generating a time sheet at a reporting device are also disclosed.

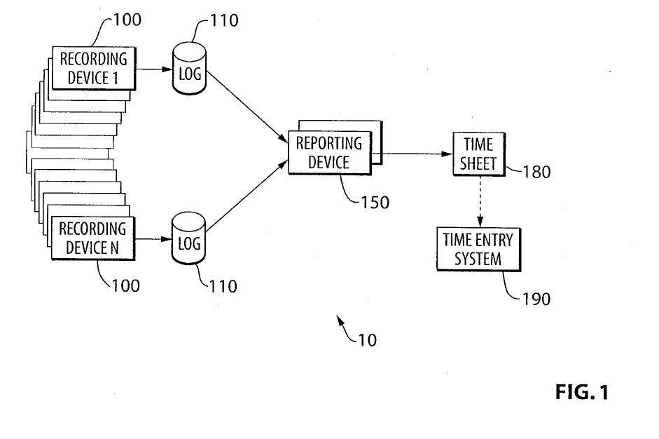

Turning now to FIG. 1, there is shown a block diagram illustrating a system for creating a time sheet in accordance with one example embodiment of the present disclosure. The system 10 comprises at least one activity-recording device 100 and at least one reporting device 150. In some example embodiments, the system 10 also comprises a time-entry based system 190, which may be a conventional system such as, by way of non-limiting example, a time sheet system, a project management system, an accounting system or any combination of these.

Each recording device 100 tracks activity involving the recording device 100 and creates a chronologically-identifiable record of such activity, from which a client or project identification to which the activity is attributable may be obtained, determined or inferred, in the form of log entries in an associated log file 110. In some example embodiments, the identification may be obtained, by way of non-limiting example, from a telephone number, an e-mail address, a contact in a directory, a subject line of an e-mail, a calendar event, an active window, a web-site address, a name of a document, a name of an active application or any combination of these.

In some example embodiments, the recording device 100 may have conventional capability other than as a part of the system 10 and the associated log file 110 may be maintained as part of such other conventional functionality. Any capability of the recording devices 100 that may be used, alone or in combination with other capabilities or other recording devices 100 or both, to identify a client or project with whom the activity may be attributable and to track a chronologically-identifiable activity for time-tracking purposes may be employed.

By way of a first non-limiting example, the recording device 100 may have functionality to place and receive wireless telephone calls to and from a telephone number, and the conventional telephonic functionality of such device may include a telephone log that records the start time and duration (or end time as the case may be) of each telephone call, as well as the telephone number dialed (in the case of outgoing calls) or from which the call originated (in the case of incoming calls).

In some example embodiments, such device may have, additionally or instead of the telephonic capability, functionality to send text messages such as Short Message Service (SMS), Multimedia Message Service (MMS), Personal Identification Number (PIN) text messages or any combination of them, and the conventional text messaging functionality of such device may include a data log of text messages sent and received, the time of, as well as the destination or origin (as the case may be) of such text message (in terms of a telephone number, PIN and/or text message address).

By way of a second non-limiting example, the recording device 100 may have capability to maintain a calendar of user-specified events or to provide alarms at the outset of upcoming events or both, and the conventional event-keeping functionality of such device may include the calendar data itself, a log of the occurrence of alarms as to upcoming events and when such alarms were cancelled, or both.

By way of a third non-limiting example, the recording device 100 may have capability to send or receive or both e-mails or other electronic messages, and the conventional e-mail functionality of such device may include the e-mails sent and received or their headers, which reflect the destination or origin (as the case may be), together with the time sent or received (as the case may be) of the e-mail.

By way of a fourth non-limiting example, the recording device 100 may have capability to monitor data points consisting of geographic coordinates of the recording device 100 determined continuously or intermittently and in some example embodiments to chart a path from an initial point to a terminal point characterized by a street address, an intersection of streets, a pre-configured point of interest, a geographical coordinate or any of these, using waypoints or other mechanism, and the conventional functionality of such device may include a log of data points, waypoints or terminal points reached, together with the time that this was achieved.

By way of a fifth non-limiting example, the recording device 100 may have capability to access uniform resource locators (URLs), domain names or web addresses, and the conventional functionality of such device may include a log of web resources accessed, together with the time that this was achieved.

By way of a sixth non-limiting example, the recording device 100 may have capability to record and to playback visual or aural media or both, such as photographs, video footage, or recording of sounds, including without limitation, lectures or meetings, and the conventional functionality of such device may include a title or header of such media, together with the time that this media as recorded or played back.

By way of a seventh non-limiting example, the recording device 100 may have capability to retrieve, review, display, edit, save, print (or any combination of these) electronic documents in any number of formats, and the conventional functionality of such device may include a log of accesses of such documents, together with the start time and duration (or end time as the case may be) that this was achieved.

By way of an eighth non-limiting example, the recording device 100 may have computational capability to receive computer instructions from an application in source, object, interpreted or executable format and to execute such instructions to provide application capability, and the conventional functionality of such device, when executing such instructions to provide the application capability, may include chronologically-identifiable log data for such application.

In some example embodiments, the recording device 100 may maintain user interfaces for different capabilities in different windows or display frames, and the conventional functionality of such windowing capability of such device may include identifying which application or window is active, completely visible to a user of the device, subject to any user inputs to the device or any combination of these, together with the start and duration (or end time as the case may be) of such status. In some example embodiments, the absence of any user inputs for a pre-determined duration (by way of non-limiting example, 5 minutes), may result in a “No Activity” log entry instead of a log entry representative of an active window.

In some example embodiments, the recording device 100 may be a handheld, mobile or desktop device or networked system such as a private branch exchange (PBX) or telephone switch (not shown). In some example embodiments, the recording device 100 may be connected through a wired, wireless or both connection to a network for communication with other devices including, without limitation, the reporting device 150 and a device (not shown) maintaining the log file 110 associated with the recording device.

In some example embodiments, the recording device 100 and the reporting device 150 may be the same device, having multiple application capabilities. In some example embodiments, the recording device 100 may be, by way of non-limiting example, a cellular telephone, a PBX, a telephone switch, a PDA, or a handheld, notebook, desktop or network computer.

The particular nature and number of recording devices 110 and their respective capabilities is generally unimportant. In some example embodiments, the capability may be capable of, by way of non-limiting example, recording a telephone discussion, a voice message being recorded, a telephone communication attempt, a voice message being accessed, an e-mail transmission, an access of a received e-mail, clearing of an appointment reminder, adjustment of a recording device setting, commencement of an appointment identified in t he recording device 100, access of an application, access of a window and a manual activity entry.

The system 10 will operate with a single log file 110 of chronologically-identifiable information, whether generated in real-time or off-line. In some example embodiments, by way of non-limiting example, the chronologically-identifiable information may be a start or end date or time, a duration, any kind of temporal indicator or any combination of these.

In some example embodiments, there is one log file 110 associated with each recording device 100. In some example embodiments, there are a plurality of log files 110 associated with a given recording device 100. In some example embodiments, a given log file 110 is associated with a plurality of recording devices 100. In some example embodiments, the log file 110 may be, by way of non-limiting example, a document, an electronic data file or a data stream.

In some example embodiments, two or more of such capabilities may be provided by a single recording device 100, and each capability of a given recording device 100 may have a separate associated log file 110, or separate or integrated log data may be recorded and stored in the associated log file 110.

The log file 110 associated with each reporting device 100 maintains chronologically-identifiable and non-chronologically identifiable information, from which may be obtained a client or project to which the activity described is attributable, associated with a capability of the associated reporting device 100. The information is accessible by one or more of the reporting devices 150 for processing.

In some example embodiments, as described above, the log file 110 is generated as part of the conventional functionality of a capability of the reporting device 100. In some example embodiments, the information is generated by a separate monitoring capability specifically associated with the system 10 by monitoring non-chronologically identifiable information conventionally generated by the capability being monitored, by monitoring in real-time the capability being monitored and generating and associating chronologically-identifiable information during such monitoring, or any combination of these.

In some example embodiments, the information of two different capabilities are in a common format. In some example embodiments, post-processing may be applied to the information of one format to conform it to a different format, including without limitation, to a format of a different capability. In some example embodiments, such post-processing may be performed by a device associated with the log file 110, which in some example embodiments may be the recording device 100, one of the reporting devices 150 or both.

In some example embodiments, the information in a log file 110 is accessible by one of the reporting devices 150, by a device associated with the log file 110 (which in some example embodiments may be the recording device 100) transmitting the information to one of the reporting devices 150 as it is generated, in batch mode periodically or intermittently, or any combination of them.

In some example embodiments, the information in a log file 110 is accessible by one of the reporting devices 150, by one of the reporting devices 150 retrieving the information as needed, in batch mode periodically or intermittently, or any combination of them.

Once accessed by one of the reporting devices 150, the information is processed by one or more of the reporting devices 150 to generate a time sheet 180.

In some example embodiments, each of a number of processing actions is performed by a different reporting device 150. In some example embodiments, more than one processing action is performed by a common reporting device 150 having multiple capabilities.

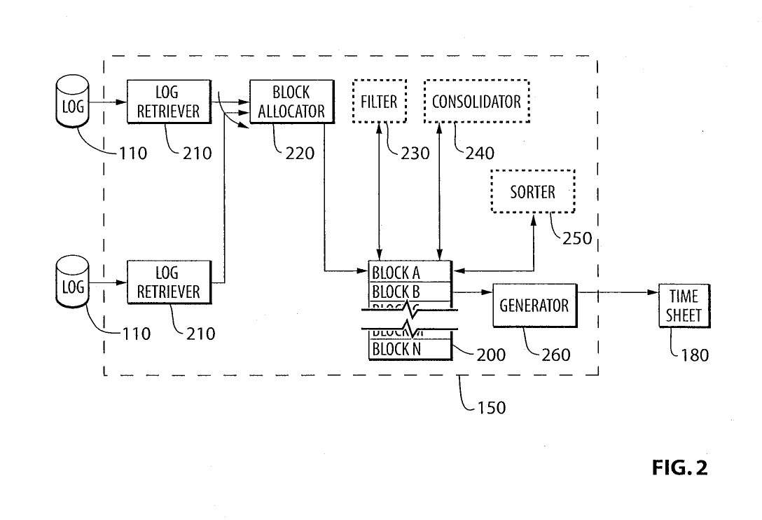

FIG. 2 is a block diagram showing the reporting devices 150. In FIG. 2, a single reporting device 150 is shown, comprising a number of components, namely a series of time blocks 200, at least one log retriever 210, a block allocator 220, a filter 230, a consolidator 240, a sorter 250 and a time sheet generator 260. As will be discussed herein, each of the block allocator 220, filter 230, consolidator 240, sorter 250 and time sheet generator 260 operate on the time blocks 200, with the result that these components 220, 230, 240, 250, 260 could operate in distributed format and comprise, individually or in combination, a plurality of reporting devices 150 as suggested in FIG. 1. For ease of illustration, the various components 220, 230, 240, 250, 260, together with the plurality of log retrievers 210 will be considered for the purposes of the present discussion as being incorporated into a single common reporting device 150.

In some example embodiments, one or more of the filter 230, consolidator 240 and sorter 250 (shown in dashed outline) may be omitted.

In some example embodiments, the various components 220, 230, 240, 250, 260 may comprise different modules of one or more reporting devices 150. In some example embodiments, any of these components may, without limitation, be implemented in software, firmware or hardware.

The series of time blocks 200 correspond to a time period to which the chronologically-identifiable information contained in the log files 110 relate. In some example embodiments, the time period covered by the time blocks 200 is contiguous and represents a desired reporting period. In some example embodiments, one or more gaps may exist in the time period covered by the time blocks 200, by way of non-limiting example, relating to non-business hours, weekend, holidays, or any combination of them.

The time blocks 200 are chronologically non-overlapping and extend across the desired reporting period. In some example embodiments, the time blocks 200 each correspond to a substantially equal time interval. In some example embodiments the time blocks 200 each correspond to a user-defined time interval. In some example embodiments, such time interval is of a convenient duration, by way of non-limiting example, one-hour or multiple hour blocks, or a fraction of an hour, by way of non-limiting example, 5 minutes, 6 minutes (0.1 of an hour), 10 minutes, 15 minutes, 20 minutes or 30 minutes. In some example embodiments, each of the time blocks 200 correspond to a minimum billing increment (by way of non-limiting example, 6 minutes (0.1 of an hour)).

In some example embodiments, the time blocks 200 start and end on a convenient boundary, by way of non-limiting example, at least one of the time blocks 200 starts or ends at an hour or half hour boundary.

The series of time blocks 200 and each of the time blocks 200 individually may comprise a structure suitable for having allocated thereto a varying number of log entries. In some example embodiments, each of the time blocks 200 may comprise or be associated with a linked-list or other suitable expandable structure, or a non-expandable structure of structural elements such as an array of sufficient size to support a pre-determined maximum number of log entries.

The log retriever 210 is in communication with one or more log entries stored in an associated log file 110 corresponding to a recording device 100, and with the block allocator 220. It accesses the log entries stored in the associated log file 110, processes them and passes them to the block allocator 220 for processing.

In some example embodiments, the processing performed by the log retriever 210 comprises converting the log entry to a common format. In some example embodiments, the processing performed by the log retriever 210 comprises extracting information from the log entries in the log file 110.

The block allocator 220 is in communication with each of the log retrievers 210 and the time blocks 200. The block allocator 220 obtains processed log entries from the log retrievers 210, further processes them and stores them in one or more of the time blocks 230.

In some example embodiments, the block allocator 220 obtains processed log entries from each of the log retrievers 210 individually. In some example embodiments, the block allocator 220 obtains processed log entries from each of the log retrievers 210 concurrently. In some example embodiments, the block allocator 220 obtains all log entries from a log file 110 concurrently. In some example embodiments, the block allocator 220 obtains only a portion of all log entries, including, without limitation, a single log entry, from a log file 110 at a time. In some example embodiments, the block allocator 220 requests one or more log files 110 from the log retriever 210. In some example embodiments, the log retriever 210 provides the log files 110 to the block allocator 220 continuously as accessed, periodically, intermittently, or any combination of them.

In some example embodiments, there is a log retriever 210 for each log file 110. In some example embodiments, there is a log retriever 210 for each recording device 100. In some example embodiments a plurality of log files 110 are accessed by a common log retriever 210. In some example embodiments, a plurality of log retrievers 210 access a common log file 110.

In some example embodiments, each of the log entries accessed by the log retriever 210 correspond to a single capability of the associated recording device 100. In some example embodiments, once a log file 110 has been accessed by the log data retriever 210, the log file 110 is re-initialized or an indication is otherwise provided so that the recording device 100 associated with it may continue adding log entries to such log file 110.

The processing performed by the block allocator 220 comprises analyzing the information contained in log entries in the log files 110 and allocating allocated log entries 201 to one or more appropriate time blocks 200.

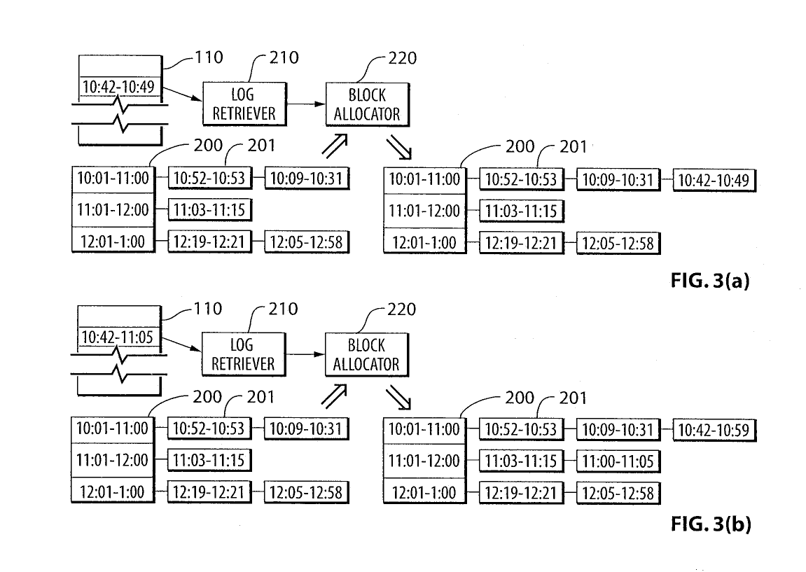

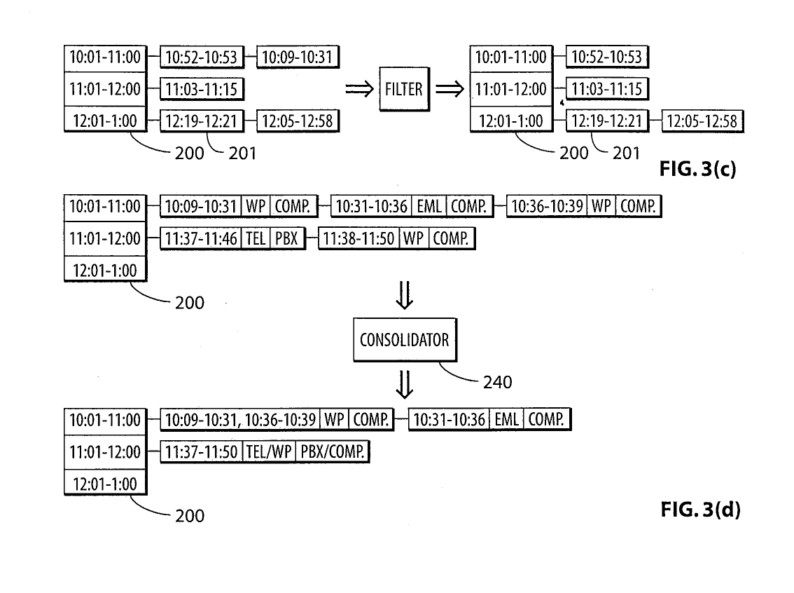

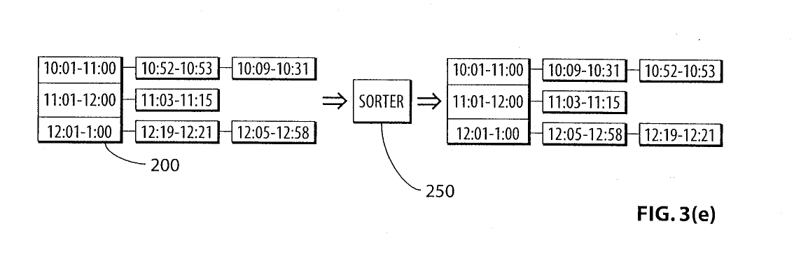

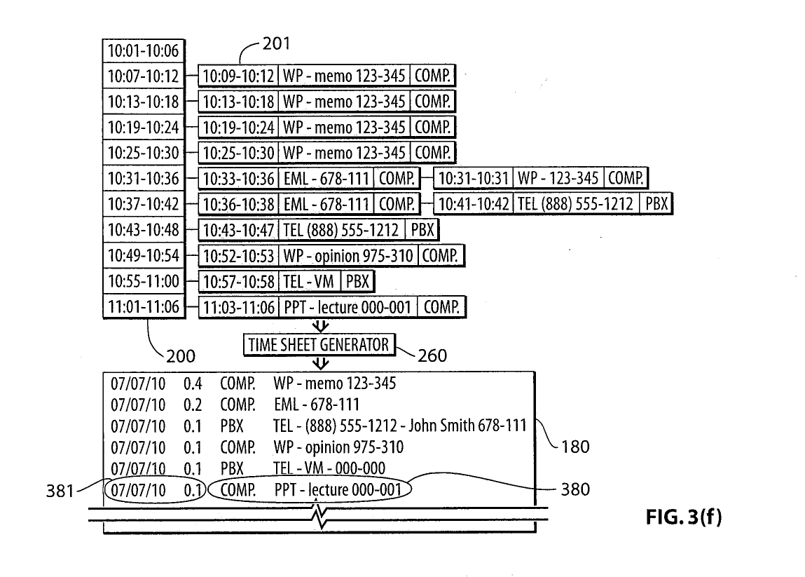

In some example embodiments, the chronologically-identifiable information of a log entry may fall entirely within a given time block 200, in which case such entry is allocated to the appropriate time block 200. Such “allocation” may comprise assigning a structural element to store or access both chronologically-identifiable and other information relating to the allocated log entry 201 in association with the structure associated with the time block 200, as shown representationally in FIG. 3(a).

In some example embodiments, a log entry may straddle a boundary between contiguous time blocks 200, in which case, such entry is allocated to the contiguous time blocks 200 straddled. The allocation of a time entry to a plurality of contiguous time blocks comprises assigning an allocated log entry 201 to store or access both chronologically-identifiable and other information relating to the log entry in association with the structure associated with each of the straddled time blocks 200, and for each of these allocated log entries 201, adjusting the chronologically-identifiable information relating to the allocated log entry 201 to only reflect chronologically-identifiable information that is associated with the particular time block 200, as shown representationally in FIG. 3(b). In effect, if a log entry straddles more than one time block 200, such log entry is split into multiple allocated log entries 201, each of which is wholly allocated within a corresponding time block 200, adjusted to reflect the appropriate start and end time or duration assigned to each allocated log entry 201.

Once a log entry has been allocated to one or more time blocks 200, such allocated log entry 201 will not be moved between time blocks 200 although, as discussed herein, an allocated log entry 201 may be deleted, combined, re-ordered, or any combination of them, within the time block 200.

The filter 230 is in communication with the time blocks 200. The filter 230 processes and updates allocated log entries 201 in the time blocks 200. The processing performed by the filter 230 comprises filtering the entries allocated to each time block 200 on a block by block basis, according to one or more criteria including, without limitation, the type of information contained in the allocated entry, the data source of the allocated entry, the duration of the allocated entry or any combination of them. By way of non-limiting example, filtering criteria may include removing allocated entries of less than a minimum duration, removing allocated entries having predetermined data, removing allocated entries having a particular identifier, removing allocated entries corresponding to a particular activity or any combination of these.

In some example embodiments, the filtering criteria may be user-specified. By way of non-limiting example, allocated log entries 201 of less than a minimum duration or items that contain certain or any data may be deleted from the time block 200. In some example embodiments, some or all of these short duration allocated log entries 201 may have their chronologically-identifiable information combined with another allocated log entry 201. In some example embodiments, such allocated log entry 201 corresponds to the same log file 110 and was immediately chronologically previous to it. By way of non-limiting example such allocated log entry may be immediately chronologically previous or subsequent to the deleted allocated log entry 201, the chronologically first or last allocated log entry 201, the allocated log entry 201 with the largest or smallest duration or any combination of these. In all of these scenarios, the non-chronologically identifiable information of the short duration allocated log entry may be discarded or subordinated to that of such remaining allocated log entry 201.

In some example embodiments, the filtering criteria may be applied globally to all time blocks 200 or to only specific time blocks 200. In some example embodiments, the filtering criteria may be applied to all allocated log entries 201 or only to allocated log entries 201 of, or representative of, a certain kind of capability, by way of non-limiting example, deleting all allocated log entries 201 corresponding to telephone calls. In some example embodiments, the filtering criteria may be applied to allocated log entries 201 containing certain characteristics, by way of non-limiting example, deleting all entries corresponding to telephone calls from a given phone number.

The consolidator 240 is in communication with the time blocks 200. The consolidator 240 processes and updates allocated log entries 201 in the time blocks 200 on a block by block basis. The processing performed by the consolidator 240 comprises combining allocated log entries 201 within a given time block 200 that match certain criteria that suggest that they are indicative of a common activity.

Allocated log entries 201 may be combined in one of two circumstances. In the first circumstance, within a given time block 200, a certain activity was initiated, then put to the side and then resumed, by way of non-limiting example, editing a word processing document, interrupted by checking of an incoming e-mail. If the capability of the recording device 100 being logged related to determination of the active window or focus of a window-based computer operating system, this might be reflected by two allocated log entries 201 allocated to a common time block 200 (in FIG. 3(d), the 10:01-11:00 time block 200) corresponding to activity in which the word processing document remains the active window, separated by activity in which the e-mail application (or the particular e-mail) became the active window. In such a scenario, the two (or more) entries in which the common word processing document remained the active window could be combined.

In the second circumstance, a common activity, by way of non-limiting example, a conference call with a client, is reflected by log entries in a plurality of different log files 110. By way of non-limiting example, this may be reflected in an allocated log entry 201 reflecting a telephone call to a given telephone number recorded by a recording device 100 that corresponds to a networked PBX (not shown) and an allocated log entry 201 corresponding to activity, roughly contemporaneous in time, in which the word processing document (representing notes taken during the telephone call) remains the active window, allocated to a common time block 200 (in FIG. 3(d), the 11:01-12:00 time block 200). In such a scenario, the two (or more) entries that match criteria that suggest that they are indicative of a common activity or a common entity with which such activity is attributable could be combined.

In either scenario, such processing could be implemented by discarding one of the allocated log entries 201 and adjusting the chronologically-identifiable information relating to another allocated log entry 201 to be combined with it to reflect the chronologically-identifiable information in relation to both allocated log entries 201, by way of non-limiting example, by adding the durations.

The mechanism by which the chronologically-identifiable information is combined, in the first scenario, may include adding the two durations or keeping track of both sets of chronologically-identifiable information. The remaining non-chronological identifiable information could be combined, with corresponding fields comprising both corresponding sets of information, either in segregated (as shown in FIG. 3(d)) or concatenated form.

In some example embodiments, by way of non-limiting example, the mechanism may comprise synchronizing the chronologically-identifiable information, adding the chronologically-identifiable information, equally distributing the chronologically-identifiable information of one allocated log entry 201 across other allocated log entries 201, distributing the chronologically-identifiable information in proportion to the chronologically-identifiable information of the other allocated log entries 201 or any combination of these.

The mechanism by which the chronologically-identifiable information is combined, in the second scenario, may include taking the earliest, latest, average, median or modal start or end time, or any combination of them, in some example embodiments by pre-determined rule. The remaining non-chronologically identifiable information could be combined, with corresponding fields comprising both corresponding sets of information, either in segregated (as shown in FIG. 3(d)) or concatenated form.

While the processing of the log retriever 210, block allocator 220, filter 230, and as discussed below, the sorter 250 are automated, the consolidator 240 may in some example embodiments be automated and in some example embodiments may take advantage of some degree of user input. The introduction of user input, whether by pre-determined user preference or by full user interaction on an allocated log entry 201 basis, using a graphical user interface (not shown), may permit the adoption of more sophisticated consolidation processing.

The sorter 250 is in communication with the time blocks 200. The sorter 250 processes and updates entries in the time blocks 200 on a block by block basis. The processing performed by the sorter 250 comprises prioritizing the allocated log entries 201 allocated to a common time block according to one or more sorting criteria. In some example embodiments, the sorting criteria may comprise by increasing or decreasing duration, chronologically by start or end time, data type, activity type, reporting device, log file or any combination of these.

In some example embodiments, if the time interval represented by a time block 200 is defined to be a minimum billing increment, selecting a sorting criteria of decreasing duration would permit the time sheet generator 260 to choose the first allocated log entry 201 for each time block 200 as and for the time entry for that billing increment.

The time sheet generator 260 is in communication with the time blocks 200 and the time sheet 180. The time sheet generator 260 processes entries in the time blocks 200 and generates the time sheet 180 from such entries. The time sheet 180 comprises at least one time sheet identifier 380 assigned to each time block 200 and an associated time entry value 381. In some example embodiments, the interval of the time block 200 corresponds to a minimum billing increment.

The time sheet identifier 380 assigned to each time block 200, is drawn from the non-chronologically identifiable information of the allocated log entries 201 associated with each time block 200. In some example embodiments, where the interval of the time block 200 corresponds to a minimum billing increment, the time sheet identifier 380 is associated with a single allocated log entry 201 associated with such time block 200. In some example embodiments, the processing performed by the time sheet generator 260 differs from the processing performed by the block allocator 220, filter 230, consolidator 240 or sorter 250 in that the determination of the time sheet identifier 380 assigned to each time block 200 may focus on the non-chronologically identifiable information such as activity type, reporting device, log file or any combination of these.

The determination of the size of the time entry value 381 to be associated with the time sheet identifier 380 is determined by adding the number of time blocks 200 having a common time sheet identifier 380. In some example embodiments, this is the case, even if the time sheet identifier 380 is drawn from an allocated log entry 201 that does not cover the entire interval represented by the time block 200 and even if other allocated log entries 201 are associated with the same time block 200.

The generated time sheet 180 could be ordered according to increasing or decreasing chronological order, size of time entry value 381, activity type, recording device 100, log file 110, or any combination of these.

In some example embodiments, the time sheet generator 260 may be automated and the time sheet identifier 380 may comprise, in whole or in part, the non-chronologically-identifiable information associated with an allocated log entry 201 (as shown in FIG. 3(e)) selected from one of the time blocks 200 from which the associated time entry value 381 is derived. In such circumstance, the quality of the time sheet 180 generated by the time sheet generator 260 may depend to some degree on both the quality of the log file 110 conventionally generated by the capability being monitored, and to some degree on policies or conventions or both, adhered to when employing such capability.

In some example embodiments, the time sheet identifier 380 may, by way of non-limiting example, be a client, client/matter, project, task, activity, a code corresponding to any of these or any combination of these.

By way of non-limiting example, if a naming convention on documents being used on a computer demands that the document be named before commencing work and that such name include within it a file number that reflects the client or project to whom the activity of working on the document is attributable, such as would be reflected by conventional document management systems, log files 110 reflecting work done on a document (or reflecting an active window in which the document was open) would automatically reflect the file number in the generated time sheet.

The quality of the time sheet 180 automatically generated by the time sheet generator 260 may also depend to some degree on the interconnection of different capabilities of one or more recording devices. By way of non-limiting example, if the recording device 100 were a networked PBX (not shown) which logs the telephone number of all calls placed, and this recording device 100 had the additional capability to resolve telephone numbers according to a contact database maintained on the recording device 100 itself or on another interconnected recording device 100 (by way of non-limiting example, a central networked docketing or contact database, or a local or global address book maintained on a computer), the logged telephone number could be correlated with a contact or a file number or both. Such correlation could take place by the recording device 100 associated with the telephone switch or PBX at the time that the telephone switch or PBX logs the telephone call in its associated log file 110 or, by the time sheet generator 260 (as shown by way of non-limiting example in FIG. 3(f)).

In some example embodiments, the time sheet generator 260 may take advantage of some degree of user input. The introduction of user input, whether by pre-determined user preference, manual override of automated actions, full user interaction on the allocated log entries 201 including specification of a time sheet identifier 380, using a graphical user interface (not shown), or any combination of these, may permit the adoption of more sophisticated time sheet generation processing.

In some example embodiments, the time sheet generator 260 may permit the association of a single time block 200, in certain circumstances, to be used in the calculation of two time entry values 381, by way of non-limiting example, to permit, in accordance with prevailing billing policies, “double billing”.

In some example embodiments, the time sheet 180 may be further processed by a time entry system 190, project management system, accounting system or other application which makes use of user activity information, in conventional fashion. In some example embodiments, the time sheet identifier 380 may be post-processed in the time entry system 190 to add to or replace the time sheet identifier 380 with an internal identifier used by the time entry system 190 such as a file number, a standard charge number, or any combination of these.

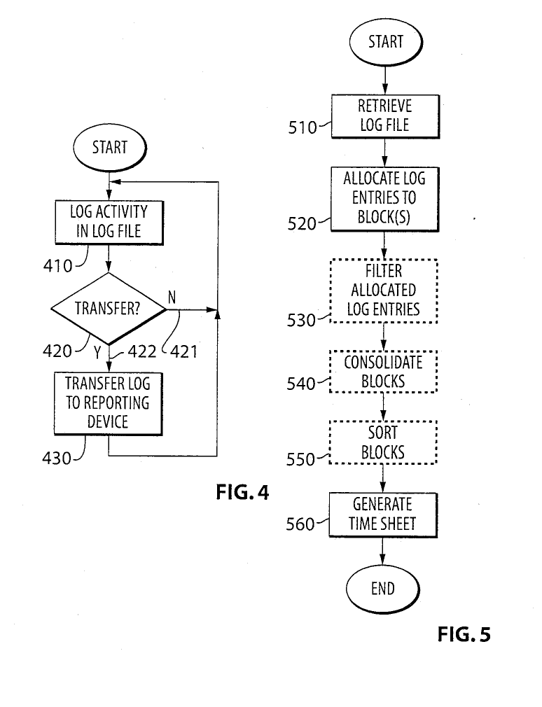

Turning now to FIG. 4, there is shown an example flow chart showing example processing actions to be taken by a recording device 100 within the system 10. Upon start up, an activity undertaken by a capability of the recording device 100 is logged (action 410) in the associated log file 110.

At decision box 420, a determination is made whether a transfer of the log file 110 as it currently stands to the reporting devices 110 is appropriate. If no (action 421), processing continues at action 410. If yes (action 422), processing continues at action 430.

At action 430, the log file 110 is transferred to the reporting device 110. As previously discussed, such transfer may be effected by the recording device 100, by one of the reporting devices 110, by another device (not shown) or any combination of these. Thereafter, processing continues at action 410.

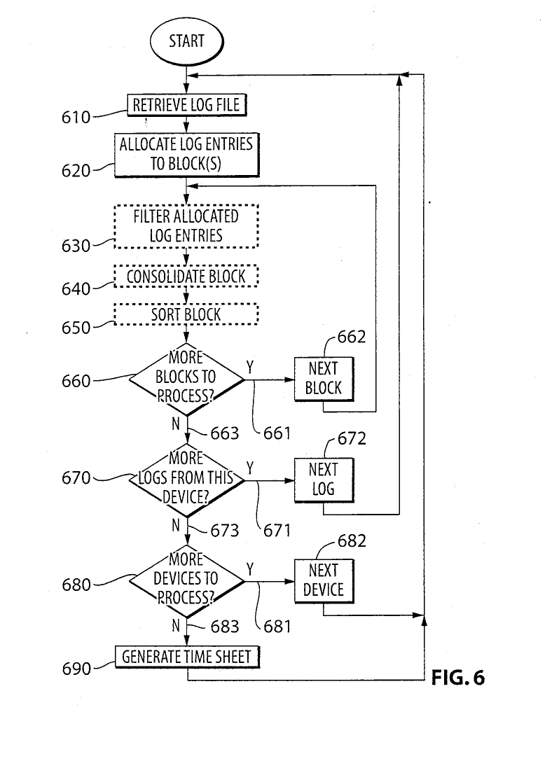

Turning now to FIG. 5, there is shown an example flow chart showing example processing actions to be taken by a reporting device 110 within the system 10. Upon start up, one of the log files 110 is retrieved (action 510). As previously discussed, such retrieval may be effected by the recording device 100 associated with the log file 110, by one of the reporting devices 110, by another device (not shown) or any combination of these.

At action 520, the log entries are allocated to one or more time blocks 200.

At action 530, the allocated log entries 201 are filtered.

At action 540, the time blocks 200 are consolidated.

At action 550, the time blocks 200 are sorted.

In some example embodiments, one or more of the filtering, consolidating and sorting actions (shown in dashed outline) may be omitted.

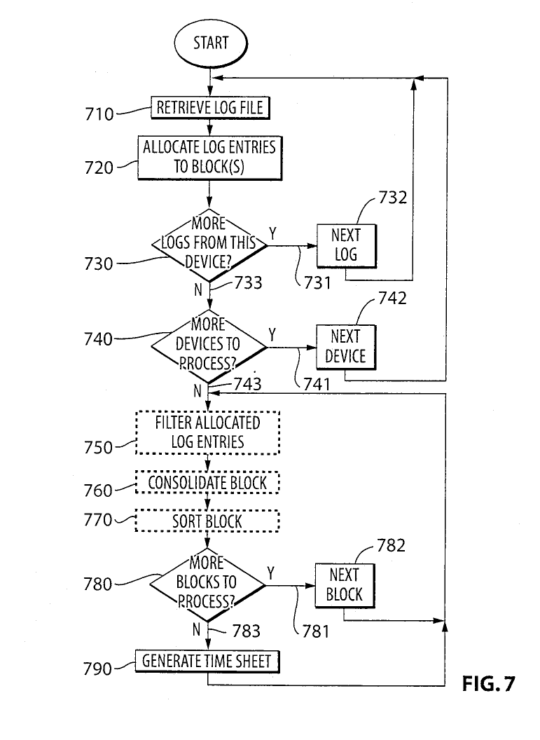

In some example embodiments, the actions of filtering, sorting and consolidating may be performed on a block by block basis. FIGS. 6 and 7 describe alternative embodiments for effecting this.

In FIG. 6, there is shown an example flow chart showing example processing actions to be taken by a reporting device 110 within the system 10. Upon start up, one of the log files 110 is retrieved (action 610). As previously discussed, such retrieval may be effected by the recording device 100 associated with the log file 110, by one of the reporting devices 110, by another device (not shown) or any combination of these.

At action 620, the log entries are allocated to one or more time blocks 200.

At action 630, the allocated log entries 201 in one of the time blocks 200 are filtered.

At action 640, one of the time blocks 200 is consolidated.

At action 650, one of the time blocks 200 is sorted.

In some example embodiments, one or more of the filtering, consolidating and sorting actions (shown in dashed outline) may be omitted.

At decision box 660, a determination is made whether there are additional time blocks 200 to process. If yes (action 621), the next time block 200 is selected (action 662) and processing continues at action 630. If no (action 663), processing continues at decision box 670.

At decision box 670, the determination is made whether there are additional log files associated with a given recording device 100 to process. If yes (action 671), the next log file 110 is selected (action 672) and processing continues at action 510. If no (action 573), processing continues at decision box 580.

At decision box 680, a determination is made whether there are additional recording devices 100 to process. If yes (action 681), the next recording device 100 is selected (action 682) and processing continues at action 610. If no (action 683), processing continues at action 690.

At action 690, the time sheet 180 is generated. Thereafter, processing continues at action 610. Alternatively, processing may terminate.

Thus, it may be seen that the processing exemplified by FIG. 6 processes each log file 110 in turn.

As shown in FIG. 7, there is shown an example flow chart showing example processing actions to be taken by a reporting device 110 within the system 10. As opposed to the processing actions shown in FIG. 6, in FIG. 7, each of the log files 110 is transferred at the outset before the processing by the reporting devices 150 commences. Upon start up, one of the log files 110 is retrieved (action 710). As previously discussed, such retrieval may be effected by the recording device 100 associated with the log file 110, by one of the reporting devices 110, by another device (not shown) or any combination of these.

At action 720, the log entries are allocated to one or more time blocks 200.

At decision box 730, the determination is made whether there are additional log files associated with a given recording device 100 to process. If yes (action 731), the next log file 110 is selected (action 732) and processing continues at action 710. If no (action 733), processing continues at decision box 740.

At decision box 740, the determination is made whether there are additional recording devices 100 to process. If yes (action 741), the next recording device 100 is selected (action 742) and processing continues at action 710. If no (action 743), processing continues at action 750.

At action 750, the allocated log entries 201 in one of the time blocks 200 are filtered.

At action 760, one of the time blocks 200 is consolidated.

At action 770, one of the time blocks 200 is sorted.

In some example embodiments, one or more of the filtering, consolidating and sorting actions (shown in dashed outline) may be omitted.

At decision box 780, the determination is made whether there are additional time blocks 200 to process. If yes (action 781), the next time block 200 is selected (action 782) and processing continues at action 750. If no (action 783), processing continues at decision box 790.

At action 790, the time sheet 180 is generated. Thereafter, processing may continue at action 710. Alternatively, processing may terminate.

It should be noted that the performance, by one or more of the reporting devices 150, of the method actions of either FIG. 6 or 7 infer the performance, in parallel, of the method actions of FIG. 4 by one or more of the recording devices 100.

While the present disclosure is sometimes described in terms of methods, the present disclosure may be understood to be also directed to various apparatus including components for performing at least some of the aspects and features of the described methods, be it by way of hardware components, software or combinations thereof, or in any other manner. Moreover, an article of manufacture for use with the apparatus, such as a pre-recorded storage device or other similar computer-readable medium including program instructions recorded thereon or a computer data signal carrying computer readable program instructions may direct an apparatus to facilitate the practice of the described methods. Such apparatus, articles of manufacture, and computer data signals also come within the scope of the present disclosure.

The term “computer readable medium” as used herein means any medium which can store instructions for use by or execution by a computer or other computing device including, but not limited to, a portable computer diskette, a hard disk drive (HDD), a random access memory (RAM), a read-only memory (ROM), an erasable programmable-read-only memory (EPROM) or flash memory, an optical disc such as a Compact Disc (CD), Digital Versatile Disc (DVD) or Blu-ray™ Disc, and a solid state storage device (e.g., NAND flash or synchronous dynamic RAM (SDRAM)).

The various embodiments presented herein are merely examples and are in no way meant to limit the scope of this disclosure. Variations of the innovations described herein will become apparent from consideration of this disclosure and such variations are within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combination will become readily apparent upon review of the present disclosure as a whole. The subject matter described herein and in the recited claims intends to cover and embrace all suitable changes in the technology.

According to a first broad aspect of the present disclosure there is disclosed a system for generating a time usage schedule of activities performed, the system comprising at least one recording device for recording at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained, and at least one reporting device for generating the time usage schedule of activities performed, the at least one reporting device comprising at least one of: an interface for retrieving at least one entry from the at least one log of the at least one recording device, a distribution hub for allocating the at least one entry from the at least one log to at least one time block based on the chronologically-identifiable information in the at least one entry, and a compiler for generating, from the entries allocated to the at least one time blocks, a time usage schedule, each activity attributable to a corresponding entity and having associated therewith a number of time blocks.

According to a second broad aspect of the present disclosure there is disclosed a recording device for recording at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained, the recording device for communication of the at least one entry with at least one reporting device, for generating a time usage schedule of activities performed, the at least one reporting device comprising at least one of: an interface for retrieving at least one entry from the at least one log of the recording device, a distribution hub for allocating the at least one entry from the at least one log to at least one time block based on the chronologically-identifiable information in the at least one entry, and a compiler for generating, from the entries allocated to the at least one time blocks, the time usage schedule, each activity attributable to a corresponding entity and having associated therewith a number of time blocks.

According to a third broad aspect of the present disclosure there is disclosed a reporting device for generating a time usage schedule of activities performed, from at least one description entry of at least one activity in at least one log recorded by at least one recording device contemporaneously with performance of the activity, the description entry comprising chronologically-identifiable information indicative of a duration of the performance of the activity and non-chronologically identifiable information from which an identification of a corresponding entity with whom the activity is attributable may be obtained, the reporting device comprising at least one of: an interface for retrieving at least one entry from the at least one log of the at least one recording device, a distribution hub for allocating the at least one entry from the at least one log to at least one time block based on the chronologically-identifiable information in the at least one entry, and a compiler for generating, from the entries allocated to the at least one time blocks, a time usage schedule, each activity attributable to a corresponding entity and having associated therewith a number of time blocks.

According to a fourth broad aspect of the present disclosure there is disclosed a method of generating, on at least one reporting device, a time usage schedule of activities performed on at least one recording device, the method comprising the actions of retrieving at least one description entry from at least one log, the description entity having been recorded in the at least one log contemporaneously with performance of an associated activity and comprising chronologically-identifiable information indicative of a duration of the performance of the activity and non-chronologically identifiable information from which an identification of a corresponding entity with whom the activity is attributable may be obtained, allocating the at least one entry from the at least one log to at least one time block based on the chronologically-identifiable information in the at least one entry, and generating, from the entries allocated to the at least one time blocks, a time usage schedule, each activity attributable to a corresponding entity and having associated therewith a number of time blocks.

According to a fifth broad aspect of the present disclosure there is disclosed a computer-readable medium in a processor in a recording device operatively coupled to a system for generating a time usage schedule of activities performed, the medium having stored thereon, computer-readable and computer-executable instructions which, when executed by the processor, cause the processor to: record at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained, the recording device for communication of the at least one entry with at least one reporting device, for generating a time usage schedule of activities performed, the at least one reporting device comprising at least one of: an interface for retrieving at least one entry from the at least one log of the recording device, a distribution hub for allocating the at least one entry from the at least one log to at least one time block based on the chronologically-identifiable information in the at least one entry, and a compiler for generating, from the entries allocated to the at least one time blocks, the time usage schedule, each activity attributable to a corresponding entity and having associated therewith a number of time blocks.

According to a sixth broad aspect of the present disclosure there is disclosed a computer-readable medium in a processor in a reporting device operatively coupled to a system for generating a time usage schedule of activities performed, the medium having stored thereon, computer-readable and computer-executable instructions which, when executed by the processor, cause the processor to: generate a time usage schedule of activities performed, from at least one description entry of at least one activity in at least one log recorded by at least one recording device contemporaneously with performance of the activity, the description entry comprising chronologically-identifiable information indicative of a duration of the performance of the activity and non-chronologically identifiable information from which an identification of a corresponding entity with whom the activity is attributable may be obtained, the reporting device comprising at least one of: an interface for retrieving at least one entry from the at least one log of the at least one recording device, a distribution hub for allocating the at least one entry from the at least one log to at least one time block based on the chronologically-identifiable information in the at least one entry, and a compiler for generating, from the entries allocated to the at least one time blocks, a time usage schedule, each activity attributable to a corresponding entity and having associated therewith a number of time blocks.

Accordingly the specification and the embodiments disclosed therein are to be considered examples only, with a true scope and spirit of the disclosure being disclosed by the following numbered claims:

What is claimed is:

1. A system for generating a time usage schedule of activities performed, the system comprising:
at least one recording device for recording at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained; and
at least one reporting device for generating the time usage schedule of activities performed, the at least one reporting device comprising at least one of:
an interface for retrieving at least one entry from the at least one log of the at least one recording device;
a distribution hub for allocating the at least one entry from the at least one log to at least one time block based on the chronologically-identifiable information in the at least one entry; and
a compiler for generating, from the entries allocated to the at least one time blocks, a time usage schedule, each activity attributable to a corresponding entity and having associated therewith a number of time blocks.

2. The system according to claim 1, wherein the at least one reporting device further comprises a filter for filtering the allocated entries according to a filtering criterion.

3. The system according to claim 1, wherein the at least one reporting device further comprises a consolidator for combining allocated entries within a time block.

4. The system according to claim 1, wherein the at least one reporting device further comprises a sorter for sorting allocated entries within a time block according to a sorting criterion.

5. The system according to claim 1, wherein the recording device is selected from a group consisting of: a cellular telephone, a private branch exchange, a telephone switch, a personal digital assistant, a handheld computer, a notebook computer, a desktop computer, a networked computer and the reporting device.

6. The system according to claim 1, wherein the activity is selected from a group consisting of a telephone discussion, a voice message recorded, a telephone communication attempt, a voice message accessed, an e-mail transmission, access of a received e-mail, clearing of an appointment reminder, adjustment of a recording device setting, commencement of an appointment identified in the recording device, access of an application, access of a window and a manual activity entry.

7. The system according to claim 1, wherein the identification may be obtained from a group consisting of: a telephone number, an e-mail address, a contact in a directory, a subject line of an e-mail, a calendar event, an active window, a web-site address, a name of a document, a name of an active application and any combination of any of the items in the group.

8. The system according to claim 1, wherein the chronologically-identifiable information is selected from a group consisting of: a start date, a start time, an end date, an end time, a duration, a temporal indicator and any combination of any of the items in the group.

9. The system according to claim 1, wherein the log is selected from a group consisting of: a document, an electronic data file and a data stream.

10. The system according to claim 1, wherein each of the at least one time blocks has a common duration.

11. The system according to claim 10, wherein the common duration is selected from a group consisting of: 5, 6, 10, 15, 20, 30, 60 minutes and a user-defined duration.

12. The system according to claim 1, wherein at least one of the time blocks commences at a boundary selected from a group consisting of an hour boundary and a half-hour boundary.

13. A recording device for recording at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained,
the recording device for communication of the at least one entry with at least one reporting device, for generating a time usage schedule of activities performed, the at least one reporting device comprising at least one of:
an interface for retrieving at least one entry from the at least one log of the recording device;
a distribution hub for allocating the at least one entry from the at least one log to at least one time block based on the chronologically-identifiable information in the at least one entry; and
a compiler for generating, from the entries allocated to the at least one time blocks, the time usage schedule, each activity attributable to a corresponding entity and having associated therewith a number of time blocks.

14. A reporting device for generating a time usage schedule of activities performed, from at least one description entry of at least one activity in at least one log recorded by at least one recording device contemporaneously with performance of the activity, the description entry comprising chronologically-identifiable information indicative of a duration of the performance of the activity and non-chronologically identifiable information from which an identification of a corresponding entity with whom the activity is attributable may be obtained, the reporting device comprising at least one of:
an interface for retrieving at least one entry from the at least one log of the at least one recording device;
a distribution hub for allocating the at least one entry from the at least one log to at least one time block based on the chronologically-identifiable information in the at least one entry; and
a compiler for generating, from the entries allocated to the at least one time blocks, a time usage schedule, each activity attributable to a corresponding entity and having associated therewith a number of time blocks.

15. A method of generating, on at least one reporting device, a time usage schedule of activities performed on at least one recording device, the method comprising the actions of:
retrieving at least one description entry from at least one log, the description entity having been recorded in the at least one log contemporaneously with performance of an associated activity and comprising chronologically-identifiable information indicative of a duration of the performance of the activity and non-chronologically identifiable information from which an identification of a corresponding entity with whom the activity is attributable may be obtained;
allocating the at least one entry from the at least one log to at least one time block based on the chronologically-identifiable information in the at least one entry; and
generating, from the entries allocated to the at least one time blocks, a time usage schedule, each activity attributable to a corresponding entity and having associated therewith a number of time blocks.

16. The method according to claim 15, wherein the action of allocating comprises decomposing the at least one entry into a plurality of entries, each of which fit entirely within and are allocated to different time blocks and assigning each allocated entry chronologically-identifiable information corresponding to temporal information lying entirely within the associated time block.

17. The method according to claim 15, further comprising before the action of generating, filtering the allocated entries in a time block according to a filtering criterion.

18. The method according to claim 17, wherein the filtering criterion is selected from a group consisting of: removing at least one allocated entry of less than a minimum duration, removing at least one allocated entry having predetermined data, removing at least one allocated entry having a particular identifier, removing at least one allocated entry corresponding to a particular activity and any combination of any of the items in the group.

19. The method according to claim 17, wherein the action of filtering comprises distributing the chronologically-identifiable information of any removed allocated entry to at least one other allocated entry in the time block.

20. The method according to claim 19, wherein the at least one other allocated entry is selected from a group consisting of: an immediately chronologically previous allocated entry, an immediately chronologically subsequent allocated entry, a chronologically first allocated entry, a chronologically last allocated entry, an allocated entry with a largest duration, an allocated entry with a smallest duration, each of the items in the group and a combination of any of the items in the group.

21. The method according to claim 15, further comprising, before the action of generating, combining allocated entries in a common time block.

22. The method according to claim 21, wherein the action of combining is selected from a group consisting of: synchronizing the chronologically-identifiable information of one of the allocated entries to be combined with the chronologically-identifiable information of another allocated entry in the time block, adding the chronologically-identifiable information of one of the allocated entries to be combined to another allocated entry in the time block, equally distributing the chronologically-identifiable information of one of the allocated entries to be combined to a plurality of allocated entries in the time block, and distributing the chronologically-identifiable information of one of the allocated entries to be combined to a plurality of allocated entries in the time block in proportion to the chronologically-identifiable information of the plurality of allocated entries in the time block, combining the non-chronologically identifiable information of one of the allocated entries to be combined with the non-chronologically identifiable information of another allocated entry in the time block in concatenated format, combining the non-chronologically identifiable information of one of the allocated entries to be combined with the non-chronologically identifiable information of another allocated entry in the time block in segregated format, combining one of the allocated entries to be combined with another allocated entry in the time block relating to a common activity, combining one of the allocated entries to be combined with another allocated entry in the time block having a common entity with whom the activity of the allocated entry to be combined is attributable, or any combination of any of the items in the group.

23. The method according to claim 15, further comprising, before the action of generating, sorting the allocated entries in a time block according to a sorting criterion.

24. The method according to claim 23, wherein the sorting criterion is selected from a group consisting of: the chronologically-identifiable information of the allocated entry, a data type of the allocated entry, a data source of the allocated entry and any combination of the items in the group.

25. The method according to claim 15, wherein the action of generating comprises associating each time block with an identifier associated with an entity with whom the activity of one of the allocated entries in the block is attributable and combining time blocks having a common identifier.

26. The method according to claim 25, wherein the identifier is obtained from the non-chronologically identifiable information of the allocated entry.

27. The method according to claim 25, wherein the identifier is selected from a group consisting of: a client, a client/matter, a project, a task, an activity, a code corresponding to any item in the group and a combination of any of the items in the group.

28. The method according to claim 15, further comprising the action of forwarding the schedule to a time-entry based system.

29. The method according to claim 28, wherein the time-entry based system is selected from a group consisting of: a time sheet system, a project management system, an accounting system and any combination of any of the items in the group.

30. A computer-readable medium in a processor in a recording device operatively coupled to a system for generating a time usage schedule of activities performed, the medium having stored thereon, computer-readable and computer-executable instructions which, when executed by the processor, cause the processor to:
record at least one description entry of at least one activity in at least one log contemporaneously with performance of the activity, the description entry comprising chronologically-identifiable information indicative of a duration of the performance of the activity and non-chronologically identifiable information from which an identification of a corresponding entity with whom the activity is attributable may be obtained,
the recording device for communication of the at least one entry with at least one reporting device, for generating a time usage schedule of activities performed, the at least one reporting device comprising at least one of:
an interface for retrieving at least one entry from the at least one log of the recording device;
a distribution hub for allocating the at least one entry from the at least one log to at least one time block based on the chronologically-identifiable information in the at least one entry; and
a compiler for generating, from the entries allocated to the at least one time blocks, the time usage schedule, each activity attributable to a corresponding entity and having associated therewith a number of time blocks.

31. A computer-readable medium in a processor in a reporting device operatively coupled to a system for generating a time usage schedule of activities performed, the medium having stored thereon, computer-readable and computer-executable instructions which, when executed by the processor, cause the processor to:
generate a time usage schedule of activities performed, from at least one description entry of at least one activity in at least one log recorded by at least one recording device contemporaneously with performance of the activity, the description entry comprising chronologically-identifiable information indicative of a duration of the performance of the activity and non-chronologically identifiable information from which an identification of a corresponding entity with whom the activity is attributable may be obtained, the reporting device comprising at least one of:
an interface for retrieving at least one entry from the at least one log of the at least one recording device;
a distribution hub for allocating the at least one entry from the at least one log to at least one time block based on the chronologically-identifiable information in the at least one entry; and
a compiler for generating, from the entries allocated to the at least one time blocks, a time usage schedule, each activity attributable to a corresponding entity and having associated therewith a number of time blocks.
